(19) United States
(12) Patent Application Publication
(10) Pub. No.: US 2008/0093843 A1
(43) Pub. Date: Apr. 24, 2008

(54) COLLAR FOR FLEXIBLE HOSE ATTACHMENT FOR VEHICLE HVAC AIR DISTRIBUTION

(76) Inventors: Homauon H. Noroozi, Rockford, MI (US); Robert I. Workman, Hastings, MI (US); Bernard L. Allers, Marne, MI (US); Ronald G. Byers, Jenison, MI (US); John C. Moleski, Ada, MI (US); James N. Wood, Hudsonville, MI (US); Gregory S. Ans, Brooklyn, OH (US); John J. Idell, Tallmadge, OH (US); Jay Honsaker, Stow, OH (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/877,281

(22) Filed: Oct. 23, 2007

Related U.S. Application Data
(60) Provisional application No. 60/862,504, filed on Oct. 23, 2006.

(51) Int. Cl. F16L 23/00

(52) U.S. Cl. 285/81

(57) ABSTRACT

A heating, ventilation, and/or air conditioning (HVAC) assembly comprising an HVAC system having an air box with a wall having an inside, an outside and an opening, a collar extending through the opening in the wall, with the collar including a base flange and a cylindrical wall extending from the base flange, the cylindrical wall including a hook member, the base flange abutting the inside of the wall and the cylindrical wall extending through the opening in the wall, and a flexible hose having a corrugated cylindrical and flexible shell, corrugated cylindrical and flexible shell having an inside and an outside, the flexible hose being connected to the collar by inserting the cylindrical wall of the collar into the inside of the shell, with the hook member of the cylindrical wall of the collar extending into grooves on the inside of the shell.

### CROSS-REFERENCE TO RELATED APPLICATION

This application claims priority to U.S. Provisional Application No. 60/862,504 filed on Oct. 23, 2006 and entitled COLLAR FOR FLEXIBLE HOSE ATTACHMENT FOR VEHICLE HVAC AIR DISTRIBUTION, the entire contents of which are hereby incorporated herein by reference.

### FIELD OF THE INVENTION

This invention is applicable to a wide range of tubing connections, but is designed for the particularly advantageous use of connecting flexible hoses to HVAC air boxes.

### SUMMARY OF THE PRESENT INVENTION

An aspect of the present invention is to provide a heating, ventilation, and/or air conditioning (HVAC) assembly comprising an HVAC system, a collar and a flexible hose. The HVAC system is for supplying air to a portion of vehicle. The HVAC system has an air box with a wall having an inside, an outside and an opening therein. The collar extends through the opening in the wall of the air box of the air conditioning system. The collar includes a base flange and a cylindrical wall extending from the base flange. The cylindrical wall includes at least one hook member. The base flange abuts the inside of the wall and the cylindrical wall extends through the opening in the wall. The flexible hose has a corrugated cylindrical and flexible shell. The corrugated cylindrical and flexible shell has an inside and an outside. The flexible hose is connected to the collar by inserting the cylindrical wall of the collar into the inside of the corrugated cylindrical and flexible shell, with the at least one hook member of the cylindrical wall of the collar extending into grooves on the inside of the corrugated cylindrical and flexible shell.

Another aspect of the present invention is to provide a collar for connecting a flexible hose to a system having an opening in a wall comprising a base flange and a cylindrical wall extending from the base flange. The cylindrical wall includes a plurality of hook members, the hook members each comprising a stepped member connected to a remainder of the collar by a living hinge. The stepped member includes at least one hook extending from an outside face of the stepped member, thereby forming steps on the stepped member. The base flange is configured to abut against an inside of the wall, the cylindrical wall is configured to extend through the opening in the wall, and the at least one hook of the hook members is configured to extend into grooves on an inside of the flexible hose to thereby connect the flexible hose to the wall without a need for further fasteners.

Yet another aspect of the present invention is to provide a method of connecting a corrugated flexible hose to a heating, ventilation, and/or air conditioning (HVAC) system comprising providing a collar including a base flange and a cylindrical wall extending from the base flange, with the cylindrical wall including at least one hook member, extending the collar through an opening in a wall of the HVAC system, inserting the cylindrical wall of the collar into the corrugated flexible hose, and engaging the at least one hook member of the collar with the corrugated flexible hose. The collar is connected to both the HVAC system and the flexible hose without any further fasteners.

These and other aspects, objects, and features of the present invention will be understood and appreciated by those skilled in the art upon studying the following specification, claims, and appended drawings.

### BRIEF DESCRIPTION OF THE DRAWINGS

The following brief description of the figures, and the related figures themselves, exemplifies a particular preferred embodiment of the invention constituting the best mode presently contemplated. As will be understood, other embodiments of the invention as well as changes and variations in the particular structure shown in these figures are no doubt possible, and may very well suggest themselves to those skilled in the art after studying this disclosure and these figures.

FIG. 1 is a front perspective view of a wall of an air box, flexible hoses and connection devices in accordance with the present invention;

FIG. 2 is a close-up front perspective view of the wall of the air box, flexible hoses and connection devices in accordance with the present invention;

FIG. 3 is a perspective view of the connection device and flexible hose in accordance with the present invention;

FIG. 4 is a top perspective view of the connection device in accordance with the present invention;

FIG. 5 is a bottom perspective view of the connection device in accordance with the present invention;

FIG. 6 is a top view of the connection device in accordance with the present invention;

FIG. 7 is a side view of the connection device in accordance with the present invention;

FIG. 8 is a cross-sectional view of the connection device in accordance with the present invention taken along the line A-A of FIG. 6;

FIG. 9 is a cross-sectional view of the connection device in accordance with the present invention taken along the line B-B of FIG. 6;

FIG. 10 is a side view of the connection device in accordance with the present invention;

FIG. 11 is a top perspective view of a second embodiment of the connection device in accordance with the present invention;

FIG. 12 is a top view of a second embodiment of the connection device in accordance with the present invention;

FIG. 13 is a side view of a second embodiment of the connection device in accordance with the present invention;

FIG. 14 is a cross-sectional view of a second embodiment of the connection device in accordance with the present invention taken along the line A-A of FIG. 12;

FIG. 15 is a cross-sectional view of a second embodiment of the connection device in accordance with the present invention taken along the line B-B of FIG. 12; and

FIG. 16 is a bottom view of a second embodiment of the connection device in accordance with the present invention.

### DETAILED DESCRIPTION

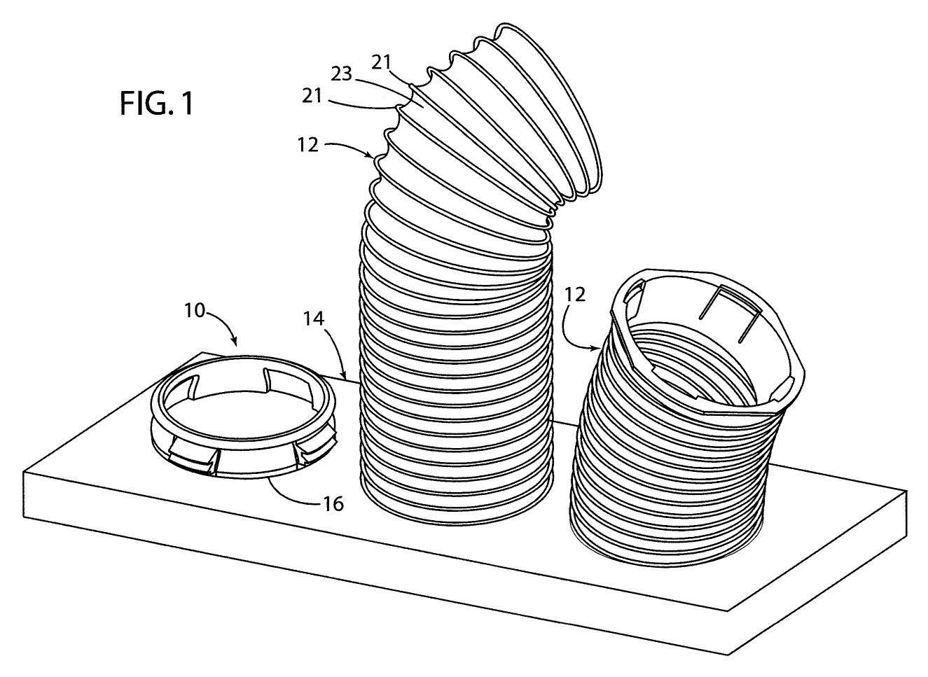

For purposes of description herein, the terms “upper,” “lower,” “right,” “left,” “rear,” “front,” “vertical,” “horizontal,” and derivatives thereof shall relate to the invention as orientated in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

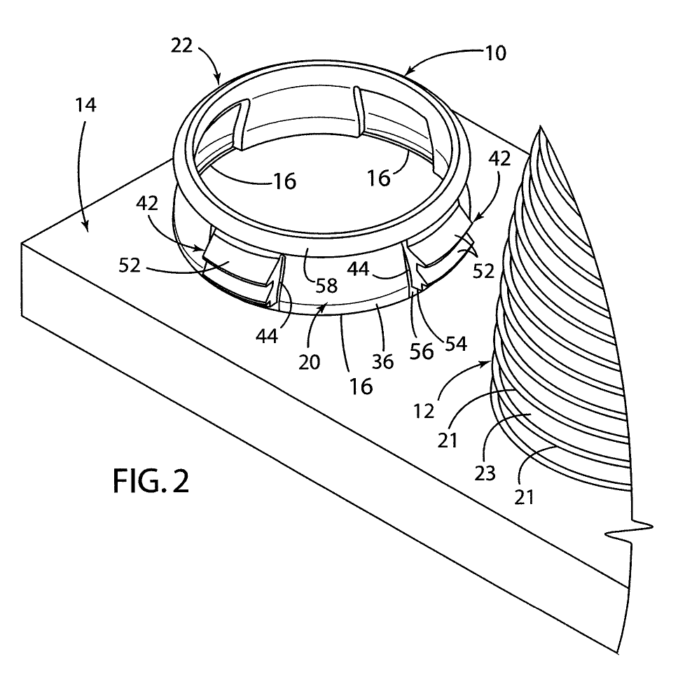

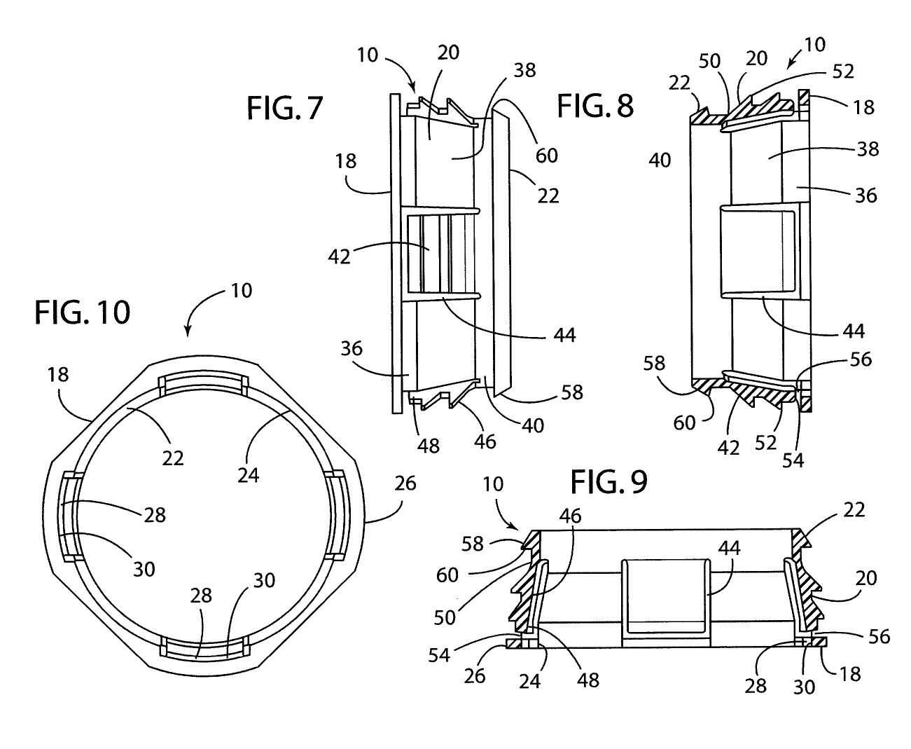

The reference number 10 (FIGS. 1-10) generally designates a connection device embodying the present invention. In the illustrated example, the connection device 10 is used to connect a flexible hose 12 to a heating, ventilation, and/or air conditioning (HVAC) system for supplying air (typically hot or cold air) to a portion of vehicle (e.g., motor home, delivery truck, etc.), with the HVAC system having an air box with a wall 14 and with the wall 14 having an inside, an outside and an opening 16 therein. As is well known to those skilled in the art, air is supplied to the air box and then transferred from the air box to different portions of the vehicle through the flexible hose 12. The wall 14 in FIG. 1 is shown to represent one of the walls of the air box. In the illustrated example, the wall 14 of the air box includes three openings 16, with one flexible hose 12 interacting with one of the openings 16. However, it is contemplated that the air box could include any number of openings (in one or more walls) for engagement with a flexible hose 12. Furthermore, it is contemplated that the connection device 10 of the present invention could be used to connect any flexible hose to any wall with an opening. The flexible hose 12 is made of a flexible material and includes a plurality of alternating ridges 21 and valleys 23 (as viewed from the outside, with the ridges 21 being valleys and the valleys 23 being ridges when viewed from the inside of the flexible hose 12), with at least the material defining the valleys 23 being flexible to allow the flexible hose 12 to compress and bend.

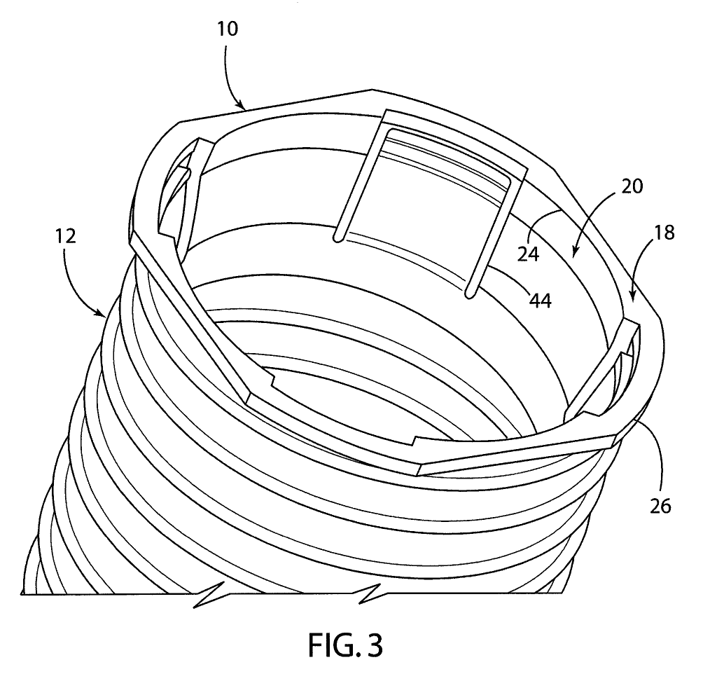

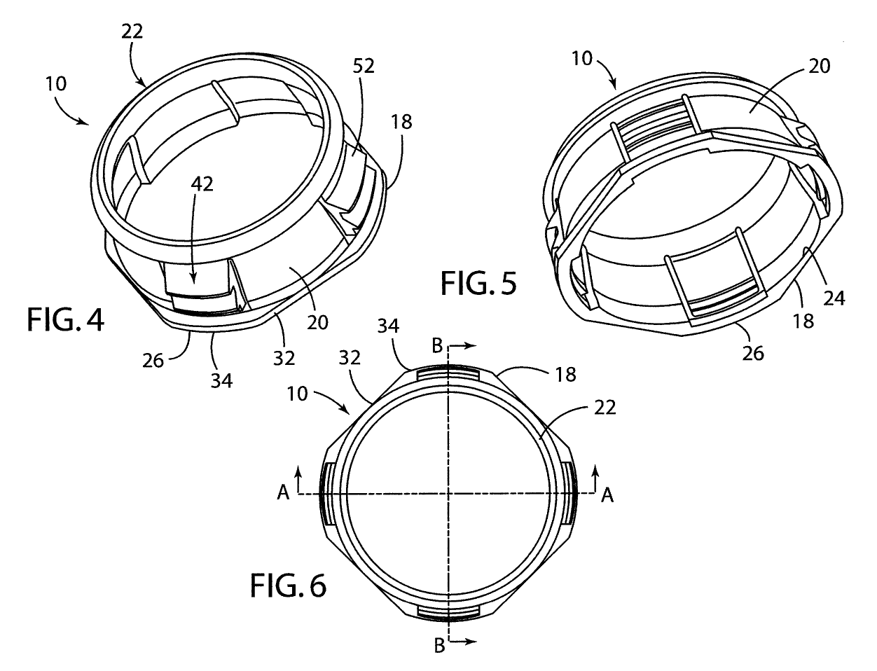

In the illustrated example, the connection device 10 (see FIGS. 4-10) is used to connect the flexible hose 12 to the air box. The connection device 10 includes a bottom flange 18, a tubular middle wall 20 and a top flange 22. The tubular middle wall 20 is between and connected to the bottom flange 18 and the top flange 22. The bottom flange 18 is substantially planar and includes an annular inside edge 24 and an outside edge 26. The annular inside edge 24 includes four grooves 28, with each groove 28 having an arcuate back wall 30. The four grooves 28 are located at 0°, 90°, 180° and 270° as illustrated in FIG. 10. The outside edge 26 includes four straight sections 32 and four curved sections 34, with each curved section 34 being located between two of the straight sections 32. The four straight sections 32 substantially define a portion of four sides of a square.

The illustrated tubular middle wall 20 of the connection device 10 includes an interrupted circular bottom portion 36, an interrupted frusto-conical middle portion 38, a circular top portion 40 and a plurality of hook members 42. The circular bottom portion 36 is connected to the bottom flange 18 at a first end and to the interrupted frusto-conical middle portion 38 at a second end. Furthermore, the circular top portion 40 is connected to a top of the frusto-conical middle portion 38. The plurality of hook members 42 extend downwardly from the circular top portion 40 and extend into open spaces 44 defined by aligned interruptions in the interrupted circular bottom portion 36 and the interrupted frusto-conical middle portion 38. Each hook member 42 includes a top angled section 46 and a bottom section 48. Both the top angled section 46 and the bottom section 48 are arcuate as viewed from above. The top angled section 46 is connected to the circular top portion 40 at an area of thin material 50. The top angled section 46 includes a pair of outwardly extending hooks 52. The hooks 52 are used to connect the connection device 10 to the flexible hose 12 as discussed in more detail below. As illustrated in FIGS. 8 and 9, a bottom 54 of the bottom section 48 of the hook members 42 is spaced from a top of the bottom flange 18 to define a wall receiving space 56. The circular top portion 40 includes an angled outside surface 58 defining a bottom ledge 60 at a bottom of the angled outside surface 58.

In the illustrated example, the connection device 10 is connected to the air box by inserting the top flange 22 and the tubular middle wall 20 through the opening in the wall of the air box from inside of the air box as illustrated in FIG. 1. As the connection device is inserted through the opening, the hook members 42 will flex inwardly along the area of thin material 50. Preferably, the interrupted circular bottom portion 36 of the tubular middle wall 20 of the connection device 10 has an outside diameter substantially identical (although slightly smaller) that an inside diameter of the opening 16 in the wall 14 of the air box. Therefore, the interrupted circular bottom portion 36 of the tubular middle wall 20 of the connection device 10 will fit snugly within the opening 16 in the wall 14 of the air box. When the connection device 10 is fully inserted into the opening 16 in the wall 14 of the air box, the bottom flange 18 of the connection device 10 will abut against the inside opening 16 in the wall 14. Furthermore, the hook members 42 will flex outwardly and cover the wall 14 just outside of the opening 16, thereby capturing the wall 14 between the bottom 54 of the of the bottom section 48 of the hook members 42 and the top of the bottom flange 18 in the wall receiving space 56 as illustrated in FIG. 1.

The illustrated flexible hose 12 is connected to the connection device 10, and thereby to the air box, by inserting the top flange 22 and the tubular middle wall 20 of the connection device into an open end of the flexible hose 12. As the connection device 10 is inserted into the flexible hose 12, the hook members 42 will flex inwardly along the area of thin material 50 as the hooks of the hook members 42 engage the valleys 23 of the flexible hose 12. Once the top flange 22 and the tubular middle wall 20 of the connection device are fully inserted into the open end of the flexible hose 12, the hook members 42 will flex outward, thereby inserting the hooks into the ridges 21 of the flexible hose 12 to connect the flexible hose to the connection device. Furthermore, the angled outside surface 58 of the top flange of the connection device assists in aligning and inserting the connection device into the flexible hose, while also using the bottom ledge to capture one of the valleys 23 of the flexible hose 12 thereunder to assist in connecting the flexible hose 12 to the connection device. In the illustrated example, the connection device 10 can include any diameter for connecting to any diameter flexible hose. For example, the connection device 10 can have the top flange and the bottom section of the middle tubular portion having an outside diameter of approximately 2.495 inches and hooks having an outside diameter of 2.672 inches and 2.705 inches for a flexible hose having a 2.5 inch inner diameter. In another example, the connection device can have the top flange and the bottom section of the middle tubular portion having an outside diameter of approximately 2.995 inches and hooks having an outside diameter of 3.172 inches and 3.205 inches for a flexible hose having a 3.0 inch inner diameter.

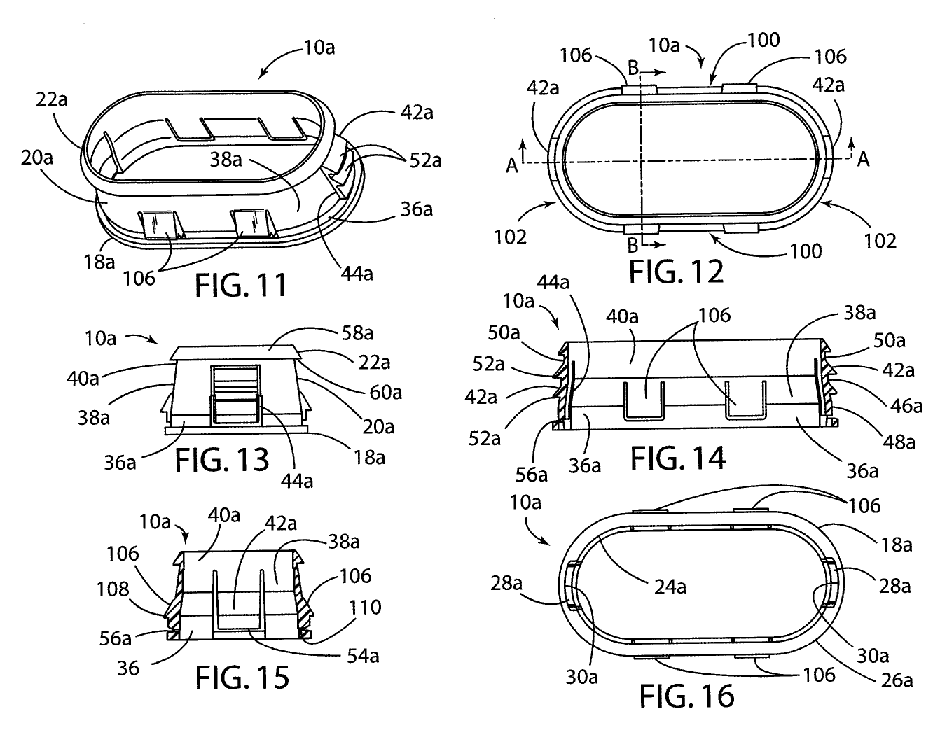

The reference numeral 10a (FIGS. 11-16) generally designates another embodiment of the present invention, having a second embodiment for the connection device. Since connection device 10a is similar to the previously described connection device 10, similar parts appearing in FIGS. 1-10 and FIGS. 11-16, respectively, are represented by the same, corresponding reference number, except for the suffix “a” in the numerals of the latter. The second embodiment of the connection device 10a is substantially oval and is configured to be connected to a flexible hose having an oval cross section, as well as one with a round cross section compressed to conform to the oval shape of the collar.

In the illustrated example, the connection device 10a is used to connect an oval flexible hose to the air box. As viewed from above (see FIG. 12), the connection device 10a includes two parallel straight sections 100 and a pair of end semi-circular sections 102 connected to the straight sections 100. The connection device 10a includes a bottom flange 18a, a tubular middle wall 20a and a top flange 22a. The tubular middle wall 20a is between and connected to the bottom flange 18a and the top flange 22a. The bottom flange 18a is substantially planar and includes an inside edge 24a and an outside edge 26a. The inside edge 24a is oval and includes two grooves 28a, with each groove 28a having an annular back wall 30a. The two grooves 28a are located in a center of each of the end semi-circular sections 102 as illustrated in FIG. 16. The outside edge 26a is also oval.

The illustrated tubular middle wall 20a of the connection device 10a includes an interrupted oval bottom portion 36a, an interrupted angled middle portion 38a, an oval top portion 40a, a plurality of hook members 42a and a plurality of wedge members 106. The oval bottom portion 36a is connected to the bottom flange 18a at a first end and to the interrupted angled middle portion 38a at a second end. Furthermore, the oval top portion 40a is connected to a top of the angled middle portion 38a. The plurality of hook members 42a extend downwardly from the oval top portion 40a and extend into open spaces 44a defined by aligned interruptions in the interrupted oval bottom portion 36a and the interrupted angled middle portion 38a. The hook members 42a are located in a center of each of the end semi-circular sections 102. Each hook member 42a includes a top angled section 46a and a bottom section 48a. Both the top angled section 46a and the bottom section 48a are arcuate as viewed from above. The top angled section 46a is connected to the oval top portion 40a at an area of thin material 50a. The top angled section 46a includes a pair of outwardly extending hooks 52a. The hooks 52a are used to connect the connection device 10a to the flexible hose in the same manner as discussed above in regard to the first embodiment of the connection device 10 (except that the opening in the wall for use with the second embodiment of the connection device 10 is also oval). As illustrated in FIG. 14, a bottom 54a of the bottom section 48a of the hook members 42a is spaced from a top of the bottom flange 18a to define a wall receiving space 56a. The oval top portion 40a includes an angled outside surface 58a defining a bottom ledge 60a at a bottom of the angled outside surface 58a. The wedge members 106 comprise two wedge members 106, with a pair of the wedge members 106 being located at one of the straight sections 100 as illustrated in FIG. 12. The wedge members 106 each include a ridge 108 and a bottom surface 110. The ridges 108 are used to connect the connection device 10a to the flexible hose in the same manner as the hooks 52a of the hook members 42a as discussed above, with the wall 14 of the air box being captured between a bottom of the bottom surface 110 of the wedge members 106 and the bottom flange 18a.

It is to be understood that variations and modifications can be made on the aforementioned structure without departing from the concepts of the present invention, and further it is to be understood that such concepts are intended to be covered by the following claims unless these claims by their language expressly state otherwise.

We claim:

1. A heating, ventilation, and/or air conditioning (HVAC) assembly comprising:
an HVAC system for supplying air to a portion of vehicle, the HVAC system having an air box with a wall, the wall having an inside, an outside and an opening therein;
a collar extending through the opening in the wall of the air box of the HVAC system, the collar including a base flange and a cylindrical wall extending from the base flange, the cylindrical wall including at least one hook member, the base flange abutting the inside of the wall and the cylindrical wall extending through the opening in the wall; and
a flexible hose having a corrugated cylindrical and flexible shell, the corrugated cylindrical and flexible shell having an inside and an outside, the flexible hose being connected to the collar by inserting the cylindrical wall of the collar into the inside of the corrugated cylindrical and flexible shell, with the at least one hook member of the cylindrical wall of the collar extending into grooves on the inside of the corrugated cylindrical and flexible shell.

2. The HVAC assembly of claim 1, wherein:
the collar further includes a top flange connected to an end of the cylindrical wall opposite the base flange, the top flange having a ramped surface for assisting insertion of the collar into the opening and the flexible hose.

3. The HVAC assembly of claim 1, wherein:
the wall is trapped between the at least one hook member and the base flange.

4. The HVAC assembly of claim 1, wherein:
the cylindrical wall of the collar is frusto-conical.

5. The HVAC assembly of claim 1, wherein:
the at least one hook member comprises a plurality of hook members;
the hook members each comprise a stepped member connected to a remainder of the collar by a living hinge, with the stepped member including at least one hook extending from an outside face of the stepped member, thereby forming steps on the stepped member; and
the at least one hook of the hook members extends into the grooves on the inside of the corrugated cylindrical and flexible shell.

6. The HVAC assembly of claim 5, wherein:
each hook member has an arcuate cross section.

7. The HVAC assembly of claim 5, wherein:
the at least one hook of the hook members comprises a plurality of hooks.

8. The HVAC assembly of claim 1, wherein:
the collar is circular.

9. The HVAC assembly of claim 8, wherein:
the at least one hook member comprises a plurality of hook members;
the hook members each comprise a stepped member connected to a remainder of the collar by a living hinge, with the stepped member including at least one hook extending from an outside face of the stepped member, thereby forming steps on the stepped member; and
the at least one hook of the hook members extends into the grooves on the inside of the corrugated cylindrical and flexible shell.

10. The HVAC assembly of claim 1, wherein:
the collar is oval.

11. The HVAC assembly of claim 10, wherein:
the at least one hook member comprises a plurality of hook members;
the hook members each comprise a stepped member connected to a remainder of the collar by a living hinge, with the stepped member including at least one hook extending from an outside face of the stepped member, thereby forming steps on the stepped member; and
the at least one hook of the hook members extends into the grooves on the inside of the corrugated cylindrical and flexible shell.

12. The HVAC assembly of claim 11, wherein:
the cylindrical wall further includes at least one wedge member, the at least one wedge member comprising a ridge, the at least one ridge extending into one of the grooves on the inside of the corrugated cylindrical and flexible shell;
the collar includes a pair of opposite substantially straight sections and a pair of opposite substantially arcuate sections, thereby forming the collar into an oval;
the hook members are located in the pair of opposite substantially arcuate sections and the at least one wedge member is located in the pair of opposite substantially straight sections.

13. A collar for connecting a flexible hose to a system having an opening in a wall comprising:
a base flange; and
a cylindrical wall extending from the base flange;
wherein the cylindrical wall includes a plurality of hook members, the hook members each comprising a stepped member connected to a remainder of the collar by a living hinge, with the stepped member including at least one hook extending from an outside face of the stepped member, thereby forming steps on the stepped member; and
wherein the base flange is configured to abut against an inside of the wall, the cylindrical wall is configured to extend through the opening in the wall, and the at least one hook of the hook members is configured to extend into grooves on an inside of the flexible hose to thereby connect the flexible hose to the wall without a need for further fasteners.

14. The collar of claim 13, wherein:
the collar further includes a top flange connected to an end of the cylindrical wall opposite the base flange, the top flange having a ramped surface for assisting insertion of the collar into the opening and the flexible hose.

15. The collar of claim 13, wherein:
the cylindrical wall of the collar is frusto-conical.

16. The collar of claim 13, wherein:
each hook member has an arcuate cross section.

17. The collar of claim 13, wherein:
the at least one hook of the hook members comprises a plurality of hooks.

18. The collar of claim 13, wherein:
the collar is circular.

19. The collar of claim 13, wherein:
the collar is oval.

20. The collar of claim 19, wherein:
the cylindrical wall further includes at least one wedge member, the at least one wedge member comprising a ridge, the at least one ridge extending into one of the grooves on the inside of the corrugated cylindrical and flexible shell;
the collar includes a pair of opposite substantially straight sections and a pair of opposite substantially arcuate sections, thereby forming the collar into an oval;
the hook members are located in the pair of opposite substantially arcuate sections and the at least one wedge member is located in the pair of opposite substantially straight sections.

21. A method of connecting a corrugated flexible hose to a heating, ventilation, and/or air conditioning (HVAC) system comprising:
providing a collar including a base flange and a cylindrical wall extending from the base flange, the cylindrical wall including at least one hook member;
extending the collar through an opening in a wall of the HVAC system;
inserting the cylindrical wall of the collar into the corrugated flexible hose; and
engaging the at least one hook member of the collar with the corrugated flexible hose;
wherein the collar is connected to both the HVAC system and the flexible hose without any further fasteners.

22. The method of connecting a corrugated flexible hose to an HVAC system of claim 21, wherein:
providing the collar further includes providing the collar with a top flange connected to an end of the cylindrical wall opposite the base flange, the top flange having a ramped surface for assisting insertion of the cylindrical wall of the collar into the opening and the flexible hose.

23. The method of connecting a corrugated flexible hose to an HVAC system of claim 21, further including:
trapping the wall between the at least one hook member and the base flange.

24. The method of connecting a corrugated flexible hose to an HVAC system of claim 21, wherein:
the collar is circular;
the at least one hook member comprises a plurality of hook members;
the hook members each comprise a stepped member connected to a remainder of the collar by a living hinge, with the stepped member including at least one hook extending from an outside face of the stepped member, thereby forming steps on the stepped member; and
engaging the at least one hook member with the corrugated flexible hose comprises extending the at least one hook of the hook members into grooves on an inside of the flexible hose.

25. The method of connecting a corrugated flexible hose to an HVAC system of claim 21, wherein:
the collar is oval;
the at least one hook member comprises a plurality of hook members;
the hook members each comprise a stepped member connected to a remainder of the collar by a living hinge, with the stepped member including at least one hook extending from an outside face of the stepped member, thereby forming steps on the stepped member;
engaging the at least one hook member with the corrugated flexible hose comprises extending the at least one hook of the hook members into grooves on an inside of the flexible hose;
the cylindrical wall further includes at least one wedge member, the at least one wedge member comprising a ridge;
the collar includes a pair of opposite substantially straight sections and a pair of opposite substantially arcuate sections, thereby forming the collar into an oval;
the hook members are located in the pair of opposite substantially arcuate sections and the at least one wedge member is located in the pair of opposite substantially straight sections; and
further including engaging the at least one wedge member with the flexible hose by extending the at least one ridge into a groove on the inside of the flexible hose.
